(19) United States
(12) Patent Application Publication
(10) Pub. No.: US 2009/0242519 A1
(43) Pub. Date: Oct. 1, 2009

(54) WELDING OF AN ELEMENT OF A TRACK UNIT AND A RAIL SECTION WITHOUT ADDING ANY MATERIAL

(76) Inventors: Serge Baumert, Vaudemange (FR); Philippe Mugg, Haguenau (FR)

Correspondence Address: YOUNG & THOMPSON, 209 Madison Street, Suite 500, ALEXANDRIA, VA, 22314, US

(21) Appl. No.: 12/419,001

(22) Filed: Apr. 6, 2009

Related U.S. Application Data
(63) Continuation of application No. 10/516,913, filed on Jun. 3, 2005.

(30) Foreign Application Priority Data
Jun. 5, 2002 (FR) 02/06922

(51) Int. Cl. B23K 11/04

(52) U.S. Cl. 219/100

(57) ABSTRACT

The stretch of rail comprises a railway switch element (12) made from high-alloy steel, in which at least one alloy element has a content equal to at least 5% by weight, and a length of rail (14) made from steel, connected to one another by a weld without deposition of metal. The length of rail (14) is formed from a medium-alloy low-carbon steel of which the carbon content is less than 0.55% by weight.

This is a continuation of application Ser. No. 10/516,913, filed Jun. 3, 2005, currently pending, which is a 371 National Stage application of International application no. PCT/FR2003/01575, filed May 23, 2003, which claims priority to French application no. 02/06922, filed Jun. 5, 2002. The entire contents of the above-referenced applications are hereby incorporated by reference in their entirety.

The present invention relates to a stretch of rail of the type comprising a railway switch element made from high-alloy steel, in which at least one alloy element has a content equal to at least 5% by weight, and a length of steel rail, connected to one another by a weld without deposition of metal.

The invention relates in particular to the connection between a switch such as a crossing frog and a section of rail consisting for example of a running line rail made from carbon steel.

### BACKGROUND OF THE INVENTION

It is known that, when a part made from carbon steel is welded to a part made from high-alloy steel the fusion produced during this operation causes, at the interface between the two parts, the formation of alloys of which the chemical composition is different from that of the basic materials. When the welding is done without deposition of metal, for example by flash welding, it is difficult to control the nature of the alloys created. Therefore, the weld produced is generally of mediocre quality, rather more like glueing.

The carbon rails currently used to make the rails of running lines include a quantity of carbon of between 0.55% and 0.8% by weight. In order to ensure a sufficient hardness, the rails have additions of other metals such as chromium. However, the high quantity of chromium makes welding impossible between two steels which are too highly alloyed.

In order to solve the problem mentioned above, it is known to provide an insert forming an intermediate part between the railway switch element made from high-alloy steel and the length of rail. This intermediate part is formed from a material capable of being welded easily onto the railway switch element on the one hand and onto the length of rail on the other hand.

The use of such an intermediate part increases the cost of implementing the connection process, particularly because of the specific characteristics of the material forming the insert and the necessity of providing two welds. Moreover, falls in hardness are observed in the length of rail, in the zone heat-affected by the energy of the welding.

### SUMMARY OF THE INVENTION

The object of the invention is to propose a solution which makes it possible to ensure a satisfactory level of hardness of the switch element and of the length of rail, and also of the connection between the switch element and the length of rail, without increasing the cost of producing the connection between them.

To this end, the invention relates to a stretch of rail of the aforementioned type, characterised in that the length of rail is formed from a low-carbon steel in which the carbon content is less than 0.55% by weight.

According to particular embodiments, the stretch of rail has one or more of the following characteristics:
the length of rail is formed from a low-carbon steel of which the medium-alloy carbon content is less than 0.5% by weight;
the medium-alloy low-carbon steel forming the length of rail is a bainitic steel;
the medium-alloy low-carbon steel forming the length of rail has the following composition by weight:
   0.05% to 0.50% of carbon;
   0.5% to 2.5% of manganese;
   0.6% to 3% of silicon or aluminium;
   0.25% to 3.1% of chromium; and
   0% to 0.9% of molybdenum;
the medium-alloy low-carbon steel forming the length of rail has a composition defined below:
   0.28% to 0.36% of carbon;
   1.40% to 1.70% of manganese;
   at most 0.03% of phosphorus;
   0.01% to 0.03% of sulphur;
   at most 0.005% of aluminium;
   1% to 1.40% of silicon;
   0.40% to 0.60% of chromium;
   0.08% to 0.20% of molybdenum;
   at most 0.04% of titanium; and
   at most 0.004% of boron; and
the railway switch element made from high-alloy steel comprises 12% to 14% by weight of manganese.

The invention will be better understood by reading the description which follows, given solely by way of example and with reference to the drawings, in which:

### BRIEF DESCRIPTION OF THE DRAWINGS

FIG. 1 is a schematic view in elevation of a railway track crossing frog to which four lengths of running line rail are welded;

FIG. 2 is a photomicrograph of a weld of a stretch of rail according to the invention; and

FIGS. 3 and 4 are diagrams showing the hardness measured along the length of the stretch of rail in the region of the weld for two different embodiments of the invention.

### DETAILED DESCRIPTION OF THE DRAWING

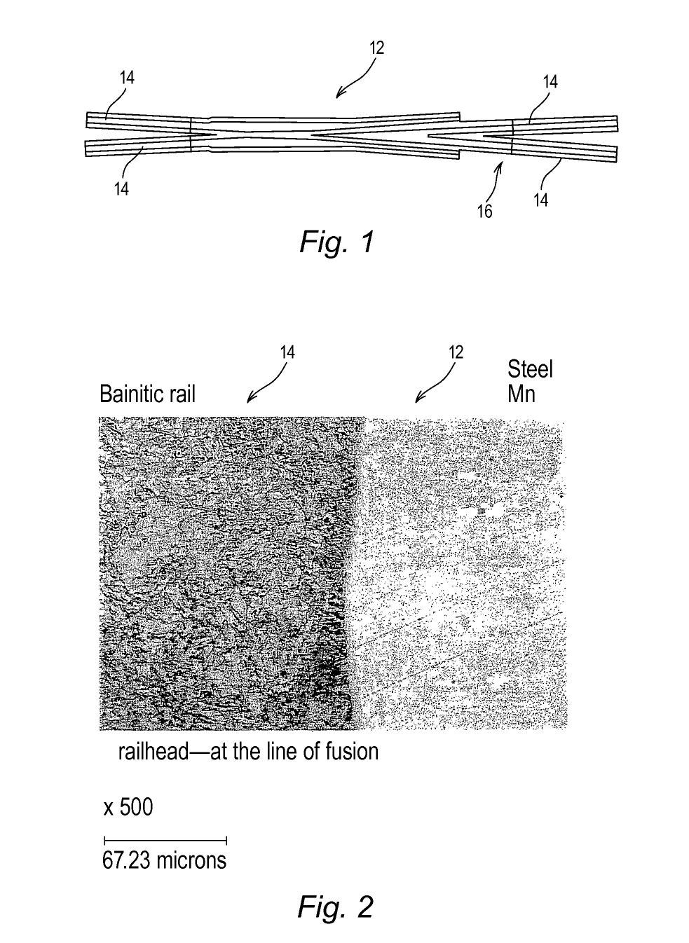

FIG. 1 shows a crossing frog which permits the crossing of two intersecting stretches of track. Thus the crossing frog 12 is connected at its four ends to four lengths of running line 14.

The lengths of line 14 are connected to the frog by welds 16 without deposition of metal.

As is known per se, the crossing frog 12 is formed from a high-alloy steel, particularly a steel in which at least one alloy element has a content equal to at least 5% by weight.

This steel is in particular an alloyed steel containing between 12% and 14% by weight of manganese, the crossing frog having been produced by moulding. This is a steel which is well known under the name of HADFIELD.

The hardness of this steel is between 170 and 230 HB.

According to the invention, the lengths of rail 14 are made from a medium-alloy low-carbon steel of which the carbon content is less than 0.55% by weight, and each weld 16 is a weld without deposition of metal produced directly between the high-alloy steel and the medium-alloy low-carbon steel. The carbon content of the medium-alloy low-carbon steel is preferably less than 0.5% by weight.

The medium-alloy low-carbon steel is preferably a bainitic steel without carbide.

The low-carbon bainitic steel forming the length of rail 14 has advantageously the following composition by weight:
0.05% to 0.50% of carbon;
0.5% to 2.5% of manganese;
0.6% to 3% of silicon or aluminium;
0.25% to 3.1% of chromium; and
0% to 0.9% of molybdenum.

Even more preferably, the bainitic steel has a composition defined below:
0.28% to 0.36% of carbon;
1.40% to 1.70% of manganese;
at most 0.03% of phosphorus;
0.01% to 0.03% of sulphur;
at most 0.005% of aluminium;
1% to 1.40% of silicon;
0.40% to 0.60% of chromium;
0.08% to 0.20% of molybdenum;
at most 0.04% of titanium; and
at most 0.004% of boron.

This steel has a hardness of between 350 and 390 HB.

The weld 16 is obtained for example by flash welding and forging according to a conventional welding cycle which is known per se.

As a variant, the weld can be obtained by induction, by friction, by electron beams, by laser or by any other high-energy beam.

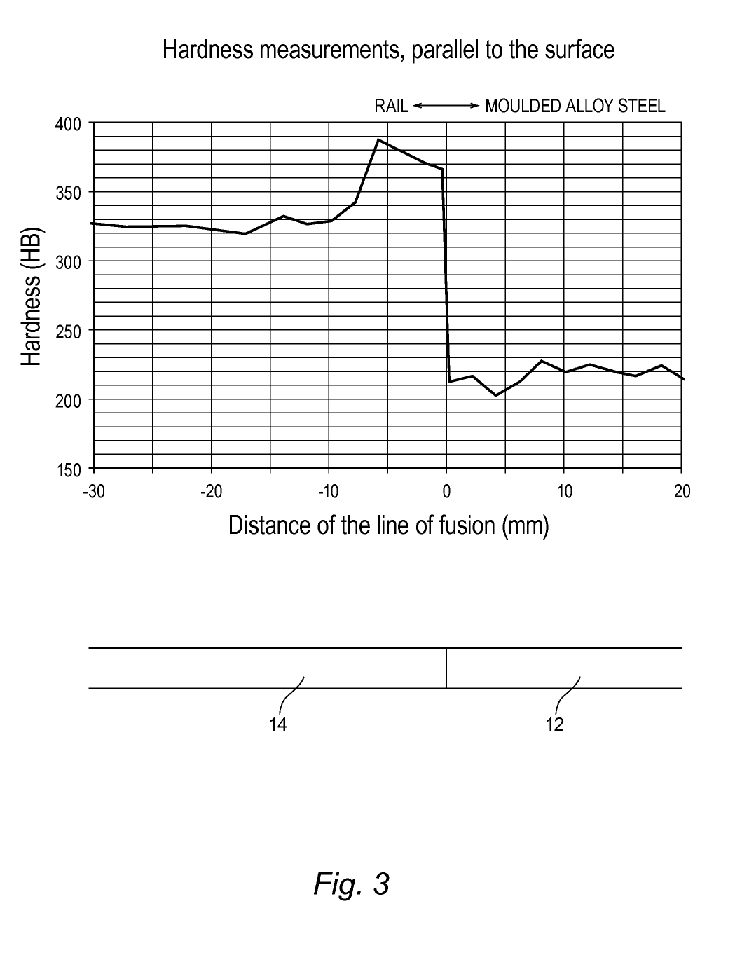

The appearance of the weld 16 which is obtained is illustrated in FIG. 2. On this microphotograph which is enlarged five hundred times it appears that the interface is very neat between the low-carbon bainitic steel and the high-alloy steel, the two steels being interpenetrated in a satisfactory manner.

According to a first embodiment which is envisaged, the switch element made from high-alloy steel is at ambient temperature before the flash welding and has a hardness resulting from re-annealing of 170 to 230 HB.

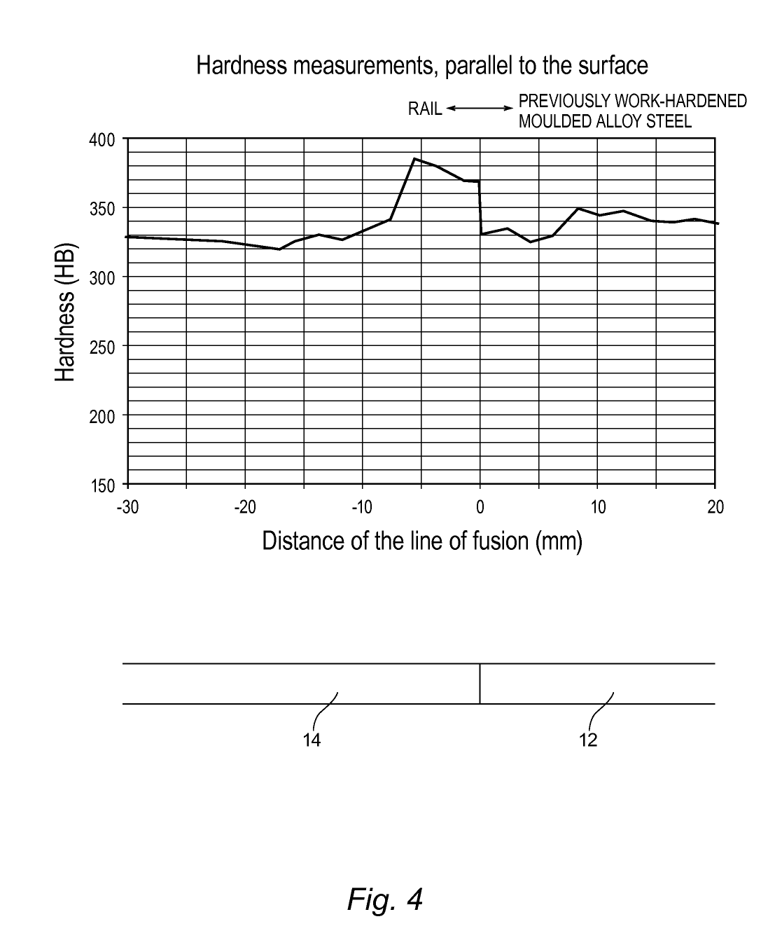

In this case the development of the hardness of the stretch of rail in the vicinity of the weld is shown in FIG. 3.

It is observed that, in its running part, the length of rail 14 has a hardness of between 290 and 330 HB and that this hardness increases to reach a value close to 380 HB in the immediate vicinity of the weld. The hardness of the stretch of rail remains at a value of between 185 and 235 HB in the switch element 12 made from high-alloy steel. This hardness corresponds to the hardness of the switch element before welding.

Therefore it is observed that with the compositions according to the invention the hardness remains satisfactory in the immediate vicinity of the weld, and is not less than the hardness specific to the two elements which are welded to one another, and that in particular there is no drop in the hardness in the heat-affected zone (HAZ).

According to a variant, the end of the switch element made from high-alloy steel which is intended to be welded is pre-hardened before the flash welding is carried out in order to increase its hardness. This pre-hardening is obtained for example by explosion.

Thus the hardness of the switch element before welding is brought to a value of between 330 and 360 HB.

With this additional step, the measurements of hardness obtained are those illustrated in FIG. 4. In this case, the hardness of the length of rail is substantially identical to that of FIG. 3. By contrast, the hardness of the switch element made from high-alloy steel in the immediate vicinity of the weld is substantially equal to 350 HB, a value substantially equal to that of the length of rail in its running portion.

1. A process for the manufacture of a stretch of rail, comprising:
directly welding a railway switch element to at least one length of rail by flash welding and forging to produce said stretch of rail, wherein:
said railway switch element is made from high-alloy steel, in which at least one alloy element has a content equal to at least 5% by weight, and said at least one length of rail is made from a medium-alloy steel having a carbon content less than 0.55% by weight and which is a bainitic steel.

2. The process of claim 1, wherein said railway switch element is directly connected to said at least one length of rail by welding without deposition of metal.

3. The process of claim 1, wherein said at least one length of rail is formed from a medium-alloy low-carbon steel in which the carbon content is less than 0.5% by weight.

4. The process of claim 1, wherein the bainitic medium-alloy low-carbon steel is without carbide.

5. The process of claim 1, wherein the medium-alloy low-carbon steel forming said at least one length of rail has the following composition by weight:
0.05% to 0.50% of carbon;
0.5% to 2.5% of manganese;
0.6% to 3% of silicon or aluminium;
0.25% to 3.1% of chromium; and
0% to 0.9% of molybdenum.

6. The process of 5, wherein the medium-alloy low-carbon steel forming said at least one length of rail has the following composition by weight:
0.28% to 0.36% of carbon;
1.40% to 1.70% of manganese;
at most 0.03% of phosphorus;
0.01% to 0.03% of sulphur;
at most 0.005% of aluminium;
1% to 1.40% of silicon;
0.40% to 0.60% of chromium;
0.08% to 0.20% of molybdenum;
at most 0.04% of titanium; and
at most 0.004% of boron.

7. The process of claim 1, wherein the railway switch element made from high-alloy steel comprises 12% to 14% by weight of manganese.

8. The process of claim 1, wherein there is no heat treatment after the welding of the railway switch element and the length of rail.

9. The process of claim 1, wherein the switch element made from the high-alloy steel has a hardness between 170 and 230 HB.

10. The process of claim 1, wherein the medium-alloy low-carbon steel has a hardness between 350 and 390 HB.
